(19) United States
(12) Patent Application Publication
(10) Pub. No.: US 2026/0254747 A1
(43) Pub. Date: Aug. 27, 2026

(54) MULTICAST ROUTING ARCHITECTURE FOR SPACE DATA NETWORKS

(71) Applicant: RTX BBN Technologies, Inc., Cambridge, MA (US)

(72) Inventors: Dylan Joseph Cirimelli-Low, Santa Cruz, CA (US); Colin Fumito Funai, Whiteland, IN (US)

(21) Appl. No.: 19/551,826

(22) Filed: Feb. 27, 2026

Related U.S. Application Data
(60) Provisional application No. 63/764,185, filed on Feb. 27, 2025.

(51) Int. Cl. H04L 45/16; H04W 40/12

(52) U.S. Cl. CPC H04L 45/16; H04W 40/12

(57) ABSTRACT

A system is provided which includes a first communications network including first nodes and a second communications network including a group of second nodes. Each of the first nodes is configured to transmit a multi-destination packet to two or more second nodes among the group of second nodes based on numerical identifiers which respectively correspond to the second nodes and are different from one another and a composite number corresponding to the group of second nodes. The composite number is a product of the numerical identifiers.

### CROSS-REFERENCE TO RELATED APPLICATIONS

This application claims the benefit of U.S. Application No. 63/764,185 filed Feb. 27, 2025, the disclosure of which is incorporated herein by reference in its entirety.

### BACKGROUND

Exemplary embodiments pertain to the art of space-ground communications, and more particularly, to a multicast routing architecture for communication between nodes of a space data network (e.g., low-orbit constellation data networks) and nodes of a ground network.

Secure space-ground communication between a space data network and a ground network can impose significant overhead on the space data network due to a low data rate associated with the space data network, compared to space-to-space or ground-to-ground communications. The overhead can further be impacted by the cost of maintaining security associations between active space and ground gateways. Due to a number of conditions such as, for example, topology dynamics and inclement weather, the quality of space-ground links (i.e., data communication links between the space data network and the ground network) can be subject to change over time. The intelligent selection of high-quality gateway links (i.e., links having stable connectivity and low packet error rate (PER)) which provide reachability to all ground nodes of the ground network and the maintenance of paths to these gateway links are two fundamental problems in this domain.

### BRIEF DESCRIPTION

Embodiments of the present disclosure provide a system and method which support the effective selection of space-ground gateways in real-time, in response to predictable events (e.g., orbital dynamics) or unpredictable events (e.g., link failures in the ground network). Such predictable events and unpredictable events can partition the ground nodes of the ground network in such a way that new space-ground gateways are needed to restore connectivity to between nodes of the space data network and the ground nodes of the ground network.

One or more embodiments may be directed to systems and methods that define a routing framework that enables delivery of multi-destination packets from space satellites to ground stations via intelligently selected communication links, in a manner which minimizes both the number of the space-ground links used and the number of transactions over the intelligently selected links.

Example embodiments of the present disclosure are directed to a system including: a first communications network including first nodes; and a second communications network including a group of second nodes, wherein each of the first nodes is configured to transmit a multi-destination packet to two or more second nodes among the group of second nodes based on: numerical identifiers which respectively correspond to the second nodes and are different from one another; and a composite number corresponding to the group of second nodes, wherein the composite number is a product of the numerical identifiers.

In any one or combination of the embodiments disclosed herein: the group of second nodes is configured to elect a gateway node from among the group of second nodes based on a comparison among the numerical identifiers; and the gateway node is configured to transmit the composite number to a first node among the first nodes via a communications link between the gateway node and the first node.

In any one or combination of the embodiments disclosed herein: each of the numerical identifiers is a prime number; and the numerical identifier of the gateway node is a smallest prime number among the numerical identifiers.

In any one or combination of the embodiments disclosed herein, the gateway node is configured to: compare quality-of-service values of network-to-network communication links respectively between the first nodes and the gateway node; and select the communications link from among the network-to-network communication links, based on a result of comparing the respective quality-of-service values.

In any one or combination of the embodiments disclosed herein: at least one of the first nodes is configured to store a directory including: the composite number, the numerical identifiers, and a mapping between the composite number and the numerical identifiers; and the at least one of the first nodes is configured to transmit control signaling including: the directory, the composite number, one or more the numerical identifiers, or a combination thereof to another first node among the first nodes.

In any one or combination of the embodiments disclosed herein: each of the first nodes is configured to transmit the multi-destination packet to the two or more second nodes, via a single second node among the two or more second nodes, wherein the single second node is configured to forward at least a portion of the multi-destination packet to another second node among the two or more second nodes, using a communication protocol associated with the second communications network.

In any one or combination of the embodiments disclosed herein: the group of second nodes is configured to self-partition into a first subgroup of second nodes and a second subgroup of second nodes; a first gateway node among the first subgroup of second nodes is configured to transmit a first composite number to a first node among the first nodes via a communications link between the first gateway node and the first node, wherein the first composite number corresponds to the first subgroup of second nodes and is a product of the numerical identifiers which respectively correspond to the first subgroup of second nodes; and a second gateway node among the second subgroup of second nodes is configured to transmit a second composite number to a different first node among the first nodes via a communications link between the second gateway node and the different first node, wherein the second composite number corresponds to the second subgroup of second nodes and is a product of the numerical identifiers which respectively correspond to the second subgroup of second nodes.

In any one or combination of the embodiments disclosed herein: the first subgroup of second nodes is configured to elect the first gateway node from among the first subgroup of second nodes based on the numerical identifier which respectively corresponds to the first gateway node; and the second subgroup of second nodes is configured to elect the second gateway node from among the second subgroup of second nodes based on the numerical identifier which respectively corresponds to the second gateway node.

In any one or combination of the embodiments disclosed herein: the group of second nodes is partitioned into a first subgroup of second nodes and a second subgroup of second nodes; a first node among the first nodes is configured to transmit at least a portion of a first multi-destination packet to a first gateway node of the first subgroup of second nodes and transmit the first multi-destination packet to another first node among the first nodes, based on: a numerical identifier corresponding to a first destination node included among the first subgroup of second nodes; a first composite number corresponding to the first subgroup of second nodes, wherein the first composite number is a product of the numerical identifiers which respectively correspond to the first subgroup of second nodes; a numerical identifier corresponding to a second destination node included among the second subgroup of second nodes; and a second composite number corresponding to the second subgroup of second nodes, wherein the composite number is a product of the numerical identifiers which respectively correspond to the second subgroup of second nodes; and the other first node among the first nodes is configured to transmit at least a second portion of the first multi-destination packet to a second gateway node of the second subgroup of second nodes, based on: the numerical identifier corresponding to the second destination node; and the second composite number corresponding to the second subgroup of second nodes.

In any one or combination of the embodiments disclosed herein: the first nodes of the first communications network are configured to transmit and receive signals between one another using a first communication protocol; the second nodes of the second communications network are configured to transmit and receive signals between one another using a second communication protocol which is different from the first communication protocol; and the first nodes of the first communications network are configured to transmit and receive signals with the second nodes of the second communications network using a third communication protocol.

Example embodiments of the present disclosure are also directed to a method of transmitting a multi-destination packet over a first communications network including first nodes and a second communications network including a group of second nodes, the method including: transmitting, via at least one first node among the first nodes, a multi-destination packet to two or more second nodes among the group of second nodes based on: numerical identifiers which respectively correspond to the second nodes and are different from one another; and a composite number corresponding to the group of second nodes, wherein the composite number is a product of the numerical identifiers.

In any one or combination of the embodiments disclosed herein, the method further includes: electing, by the group of second nodes, a gateway node from among the group of second nodes based on comparing the numerical identifiers; and transmitting, by the gateway node, the composite number to a first node among the first nodes via a communications link between the gateway node and the first node.

In any one or combination of the embodiments disclosed herein, the method further includes: each of the numerical identifiers is a prime number; and the numerical identifier of the gateway node is a smallest prime number among the numerical identifiers.

In any one or combination of the embodiments disclosed herein, the method further includes: comparing, by the gateway node, quality-of-service values of network-to-network communication links respectively between the first nodes and the gateway node; and selecting, by the gateway node, the communications link from among the network-to-network communication links, based on a result of comparing the respective quality-of-service values.

In any one or combination of the embodiments disclosed herein, the method further includes: storing, by at least one of the first nodes, a directory including: the composite number, the numerical identifiers, and a mapping between the composite number and the numerical identifiers; and transmitting, by the at least one of the first nodes, control signaling including: the directory, the composite number, one or more the numerical identifiers, or a combination thereof to another first node among the first nodes.

In any one or combination of the embodiments disclosed herein, the method further includes: transmitting, by the at least one first node among the first nodes, the multi-destination packet to a single second node among the two or more second nodes; and forwarding, by the single second node, at least a portion of the multi-destination packet to another second node among the two or more second nodes, using a communication protocol associated with the second communications network.

In any one or combination of the embodiments disclosed herein, the method further includes: self-partitioning, by the group of second nodes, into a first subgroup of second nodes and a second subgroup of second nodes; transmitting, by a first gateway node among the first subgroup of second nodes, a first composite number to a first node among the first nodes via a communications link between the first gateway node and the first node, wherein the first composite number corresponds to the first subgroup of second nodes and is a product of the numerical identifiers which respectively correspond to the first subgroup of second nodes; and transmitting, by a second gateway node among the second subgroup of second nodes, a second composite number to a different first node among the first nodes via a communications link between the second gateway node and the different first node, wherein the second composite number corresponds to the second subgroup of second nodes and is a product of the numerical identifiers which respectively correspond to the second subgroup of second nodes.

In any one or combination of the embodiments disclosed herein, the method further includes: electing, by the first subgroup of second nodes, the first gateway node from among the first subgroup of second nodes based on the numerical identifier which respectively corresponds to the first gateway node; and electing, by the second subgroup of second nodes, the second gateway node from among the second subgroup of second nodes based on the numerical identifier which respectively corresponds to the second gateway node.

In any one or combination of the embodiments disclosed herein, the method further includes: partitioning the group of second nodes into a first subgroup of second nodes and a second subgroup of second nodes; transmitting, by a first node among the first nodes, at least a portion of a first multi-destination packet to a first gateway node of the first subgroup of second nodes and transmit the first multi-destination packet to another first node among the first nodes, based on: a numerical identifier corresponding to a first destination node included among the first subgroup of second nodes; a first composite number corresponding to the first subgroup of second nodes, wherein the first composite number is a product of the numerical identifiers which respectively correspond to the first subgroup of second nodes; a numerical identifier corresponding to a second destination node included among the second subgroup of second nodes; and a second composite number corresponding to the second subgroup of second nodes, wherein the composite number is a product of the numerical identifiers which respectively correspond to the second subgroup of second nodes; and transmitting, by the other first node among the first nodes, at least a second portion of the first multi-destination packet to a second gateway node of the second subgroup of second nodes, based on: the numerical identifier corresponding to the second destination node; and the second composite number corresponding to the second subgroup of second nodes.

Example embodiments of the present disclosure are also directed to a first node included in a first communications network, the first node including: a memory having computer readable instructions and one or more processors for executing the computer readable instructions, wherein the computer readable instructions, when executed by the one or more processors, cause the first node to: transmit a multi-destination packet to two or more second nodes among a group of second nodes included in a second communications network, based on: numerical identifiers which respectively correspond to the second nodes and are different from one another; and a composite number corresponding to the group of second nodes, wherein the composite number is a product of the numerical identifiers.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

One or more embodiments may be directed to systems and methods that define a routing framework that enables delivery of multi-destination packets from space satellites to ground stations via intelligently selected communication links, in a manner which minimizes both the number of the space-ground links used and the number of transactions over the intelligently selected links.

FIG. 1A through FIG. 1C illustrate an example of a system including a routing framework that enables delivery of multi-destination packets in accordance with one or more embodiments of the present disclosure.

FIG. 2A through FIG. 2K illustrate example aspects of the delivery of a multi-destination packet using the multicast routing architecture of the system in accordance with one or more embodiments of the present disclosure.

FIG. 3A through FIG. 3E illustrate example aspects of pre-emptive path change using products as implemented by the system in accordance with one or more embodiments of the present disclosure.

FIG. 4 is a block diagram of a distributed computer system, in which various aspects and functions discussed herein may be practiced.

FIG. 5 illustrates an example flowchart of a method in accordance with one or more embodiments of the present disclosure.

For a more complete understanding of this disclosure, reference is now made to the following brief description, taken in connection with the accompanying drawings and detailed description, wherein like reference numerals represent like parts.

### DETAILED DESCRIPTION

A detailed description of one or more embodiments of the disclosed apparatus and method are presented herein by way of exemplification and not limitation with reference to the Figures.

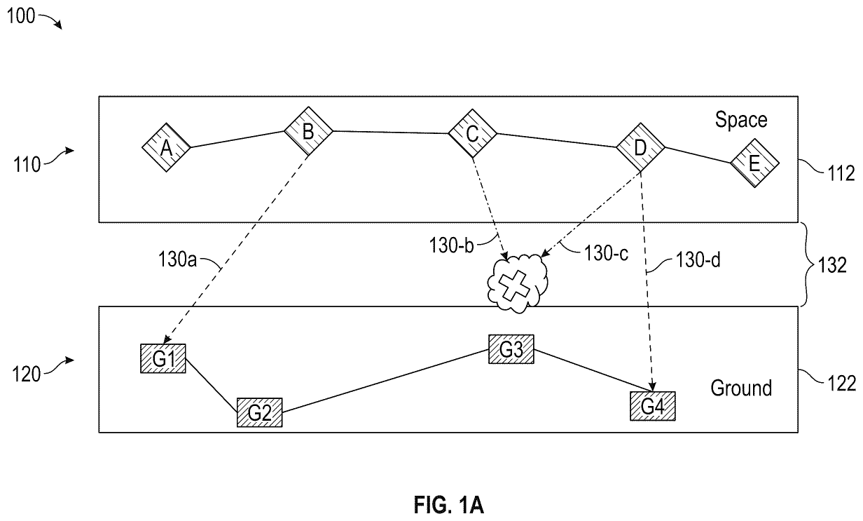

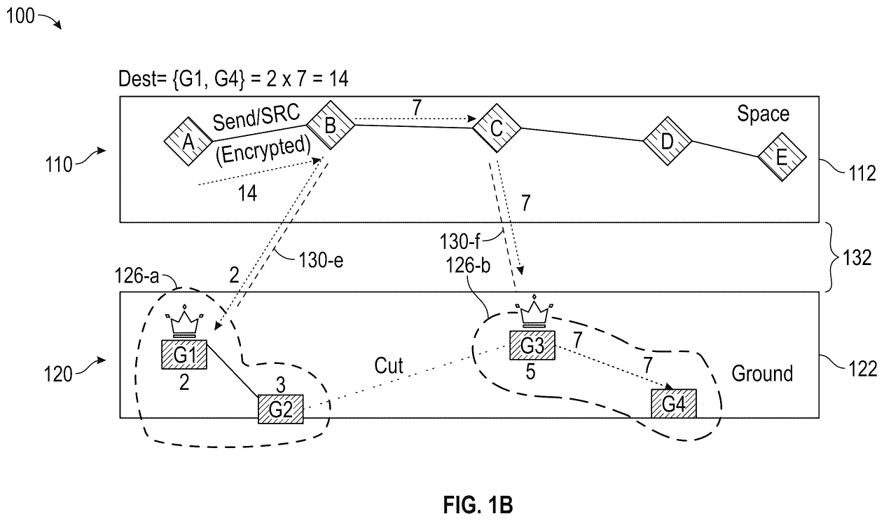

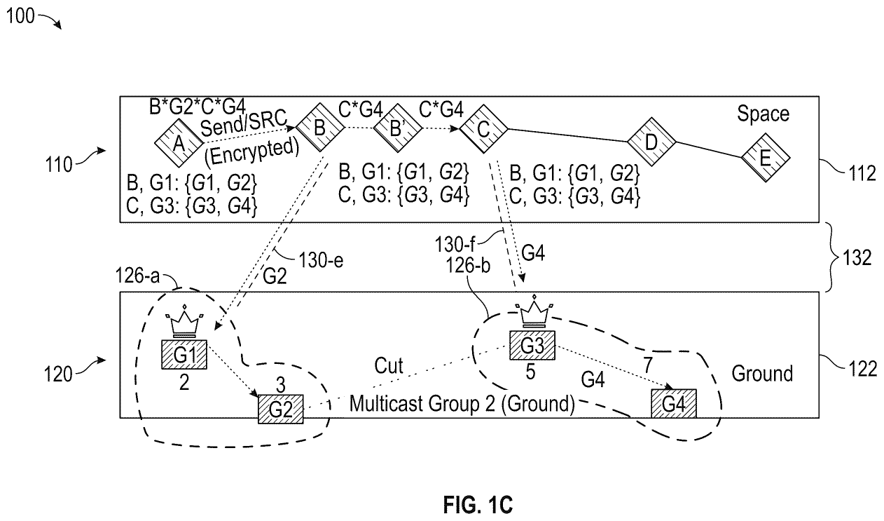

FIG. 1A through FIG. 1C illustrate an example of a system 100 including a routing framework that enables delivery of multi-destination packets from space satellites A through E of a space data network 110 to ground stations G1 through G4 of a ground network 120 in a manner that minimizes both the number of the network-to-network communication links 130 used and the number of transactions over the network-to-network communication links 130. The system 100 supports intelligently selecting the network-to-network communication links 130 using operations performed by the space data network 110 and the ground network 120. In some aspects, the system 100 may be implemented as a satellite content delivery network for delivering content from the space data network 110 to the ground network 120.

In accordance with one or more embodiments of the present disclosure, the system 100 represents multi-destination groups 124 by a single numerical value (e.g., a composite number described herein) rather than a group address. Through implementing the single value representation, the system 100 provides multi-cast network-to-network communication between the space satellites A through E of the space data network 110 and the ground stations G1 through G4 of the ground network 120, without relying on dedicated group join/leave messages and group maintenance messages. The system 100 provides a hierarchical multicast architecture which minimizes costly space-ground communication between the space data network 110 and the ground network 120. The space satellites A through E and may be referred to as nodes or space nodes of the space data network 110, and the ground stations G1 through G4 may be referred to as nodes or ground nodes of the ground network 120. The space data network 110 may include further satellites not illustrated in the figures herein, and the ground network 120 may include further ground stations not illustrated in the figures herein.

In some embodiments, the space data network 110 may be a low earth orbit (LEO) satellite network, a medium earth orbit (MEO) satellite network, a geostationary (GEO) satellite network, or the like, and the ground network 120 may be a communication network which uses an intra-network communication protocol different from the intra-network communication protocol of the space data network 110. For example, the ground network 120 may be a terrestrial or fiber network which uses communications protocols such as, for example, LTE, 4G, 5G, WiFi, Bluetooth, TDMA, CDMA, FDMA, fiber, or the like. In another example, the space data network 110 may be a GEO satellite network, and the ground network 120 may be a LEO satellite network.

In some aspects, the satellites of the space data network 110 may exchange data signals with the ground stations of the ground network 120 (via communications links 130 described herein) using a network-to-network communication protocol which is different from the intra-network communication protocol of the space data network 110 and the intra-network communication protocol of the ground network 120. In some embodiments, the satellites of the space data network 110 may exchange data signals with the ground stations of the ground network 120 using a network-to-network communication protocol which is compatible with the intra-network communication protocol of the space data network 110 and the intra-network communication protocol of the ground network 120.

It is to be understood that embodiments described herein are not limited to the space data network 110 and the ground network 120. The multicast routing architecture and network-to-network communication techniques described herein may be applied to network-to-network communication between any combination of networks which use intra-network communication protocols different from one another. For example, the multicast routing architecture and network-to-network communication techniques described herein may be applied to a first communication network which uses a first communication protocol and a second communication network which uses a second communication protocol which is different from the first communication protocol.

With reference to FIG. 1A, embodiments of the present disclosure include a space-to-space multicast algorithm (operating in a region 112 of the space data network 110), a ground-to-ground multicast algorithm (operating in a region 122 of the ground network 120), and a space-to-ground gateway selection algorithm (operating in a region 132 between the region 112 and the region 122). Aspects of the space-to-ground gateway selection algorithm are illustrated by the network-to-network communication links 130 (e.g., network-to-network communication link 130-a through network-to-network communication link 130-d) which cross through the region 132. As will be described herein, embodiments of the present disclosure utilize a multicast routing architecture which supports communication without utilizing all of the network-to-network communication links 130 (e.g., network-to-network communication link 130-c, network-to-network communication link 130-d), thereby minimizing costly communications between the space data network 110 and the ground network 120.

FIG. 1B illustrates an example of the delivery of a multi-destination packet originating from satellite A (a source node) to ground station G1 and ground station G4, via a network-to-network communication link 130-e from satellite A to ground station G1 and a network-to-network communication link 130-f from satellite A to ground station G3. In the example, the ground station G1 and the ground station G4 are destination nodes, as expressed by dest={G1, G4}=2×7=14.

The system 100 uses unique prime numbers (e.g., 2, 3, 5, 7, and the like) as identifiers for respectively identifying each of the ground stations (nodes) of the ground network 120. In the examples of FIG. 1A through FIG. 1C, the primes (prime values) assigned as identifiers for the ground stations G1, G2, G3, and G4 are respectively ‘2’, ‘3’, ‘5’, and ‘7’.

The system 100 can group the ground stations into cliques 126 (i.e., groups) of ground stations and utilize composite numbers (e.g., products of the identifiers) to represent the different groups 124. Example aspects of the prime numbers as applied to the ground stations G1 through G4 and the composite numbers are later described herein.

Each clique 126 (e.g., clique 126-a, clique 126-b) of nodes is accessible through a respective network-to-network communication link 130 which the system 100 has determined to be the relatively highest quality-of-service (QoS) space-ground link from a given source satellite to the clique 126. For example, the ground stations (i.e., ground station G1 and ground station G2) of the clique 126-a can determine that network-to-network communication link 130-e between satellite B and ground station G1 has the relatively highest QoS for communicating between the space data network 110 and the ground stations (i.e., ground station G1 and ground station G2) of the clique 126-a. In another example, the ground stations (e.g., ground station G3 and ground station G4) of the clique 126-b can determine that network-to-network communication link 130-f between the satellite C and the ground station G3 has the relatively highest QoS for communicating between the space data network 110 and the ground stations (e.g., ground station G3 and ground station G4) of the clique 126-b.

As an example, the QoS may be inclusive of bandwidth, latency, jitter, and packet loss, and embodiments of the present disclosure are not limited thereto. Examples of the system 100 determining the network-to-network communication links 130 having the relatively highest QoS are later described herein.

The system 100 maintains a distributed directory for communicating between the satellites of the space data network 110 and the ground stations of the ground network 120. The distributed directory is a maintained mapping of space gateways (e.g., network-to-network communication links 130) and clique identifiers. For example, the distributed directory is a maintained mapping of <space gateway>: <clique identifiers>. The system 100 disseminates the distributed directory among multicast sources and space gateways using a tree-based multicast.

In the examples of FIG. 1B and FIG. 1C, satellite A is a multicast source, and satellite B and satellite C are nodes each having a respective network-to-network communication link 130 of a high QoS with a ground station of the ground network 120. The satellite A intends to transmit a data packet to the ground station G1 and the ground station G4. The satellite A uses, as the multicast destination address, a destination value={G1,G4}=2×7=14.

In an example, the satellite A sends a transmission to the satellite B, in which the transmission includes the data packet of the multicast communication and the destination value of ‘14’ (i.e., the product of the respective prime identifiers ‘2’ and ‘7’ of the ground station G1 and the ground station G4). In some aspects, the transmission can include an indication of satellites for further transmitting the data packet and destination ground stations which are to receive the data packet. In an example, the transmission includes an indication ‘B*G2*C*G4’.

Further, the satellite B may forward the data packet to the satellite C via the satellite B′ (a relay node). For example, the satellite B sends a transmission to the satellite C, in which the transmission includes the data packet of the multicast communication and a destination value of ‘7’ (i.e., the prime identifier ‘7’ of the ground station G4). In an example, the transmission includes an indication ‘C*G4’.

Accordingly, for example, using the destination value of ‘14’ and the prime identifiers as assigned to the ground stations, the system 100 can deliver the data packet to the ground station G1 and the ground station G4 according to the following:
B, G1: {G1, G2}
C, G3: {G3, G4}

Further in FIG. 1C, satellite B′ is a relay (not a source or gateway) which does not have a copy of the directory, but is pre-loaded with the list of primes (prime values) respectively associated with the ground stations of the ground network 120. In an example, based on the list of primes, the satellite B′ can determine whether the satellite B′ is to forward in the direction of satellite C, by dividing out the primes respectively associated with the ground stations. As earlier described, the primes (prime values) assigned as identifiers for the ground stations G1, G2, G3, and G4 are respectively ‘2’, ‘3’, ‘5’, and ‘7’. In accordance with one or more embodiments of the present disclosure, each relay is stateless and is not limited to holding a multicast state. Each relay can refrain from participating in exchange of control signaling described herein.

Although in the example implementation described with reference to FIG. 1C, satellite A is transmitting to ‘B*G2*C*G4’, embodiments of the present disclosure are not limited thereto. For example, through assigning prime identifiers to satellite B and satellite C, the techniques described herein support implementations in which relays (e.g., satellite B′) that do not have copies of the directories can still participate in the forwarding of multi-destination packets as applicable or desired. However, embodiments of the present disclosure are not limited to both the satellites of the space data network 110 and the ground stations of the ground network 120 having prime identifiers. That is, the techniques described herein may route and address multi-destination packets through the use of prime identifiers applied to the ground stations of the ground network 120 (i.e., a composite number based on the ground stations, for example, a composite number=G2*G4), without using explicit identifiers for the satellites of the space data network 110 (i.e., without relying on B*C corresponding to satellite B and satellite C).

In a modified example implementation described with reference to FIG. 1C, satellite A can transmit a message (including G2*G4 for routing the message) to satellite B via an interface (i.e., communication link) between satellite A and satellite B. Satellite B splits the message and transmits a first portion of the message to ground station G1 via the interface (e.g., network-to-network communication link 130-e) between satellite B and ground station G1, and ground station G1 forwards the first portion of the message to ground station G2. Further, satellite B transmits a second portion of the message to satellite C via an interface (i.e., communication link) between satellite B and satellite C. Satellite C transmits the second portion of the message to ground station G3 via an interface (e.g., network-to-network communication link 130-f) between satellite C and ground station G3, and ground station G3 forwards the second portion of the message to ground station G4. Accordingly, for example, satellite B serves as the “next hop” from satellite A to the ground station G1 (destination) in the unicast routing protocol to ground station G1, and satellite C serves as the “next hop” from satellite B toward the ground station G4 (destination).

Accordingly, for example, through the use of the directory as known to the satellites of the space data network 110, the correct interface can be provided by consulting the “next hop” to the destination in the unicast routing protocol. The ground stations of the ground network 120 are grouped by clique 126 and a corresponding outgoing interface (i.e., network-to-network communication link 130) for communicating with the space data network 110, and thus in sending multi-destination packets by the space data network 110, a single multi-destination packet at most is generated per interface, thereby reducing the number of network-to-network transmissions across the region 132.

Further, though the examples described herein refer to example prime identifiers of ‘2’, ‘3’, ‘5’, ‘7’, and the like, embodiments of the present disclosure are not limited thereto. The idea of using prime numbers as node identifiers to represent destinations (i.e., ground stations) is an example. Alternative and/or additional implementations include using a bit vector to represent sets of ground stations, where a bit value of ‘1’ means inclusion and a bit value of ‘0’ means exclusion from a given clique 126.

In accordance with one or more embodiments of the present disclosure, each ground clique 126 can elect a ground gateway (i.e., clique head) and a space gateway node. For example, the ground station G1 and the ground station G2 of the clique 126-a elect the ground station G1 as the ground gateway (i.e., clique head) of the clique 126-a and elect the satellite B as the space gateway node with which the ground station G1 is to interact for network-to-network communications between the space data network 110 and the clique 126-a. Further, for example, the ground station G3 and the ground station G4 of the clique 126-b elect the ground station G3 as the ground gateway (i.e., clique head) of the clique 126-b and elect the satellite C as the space gateway node with which the ground station G3 is to interact for network-to-network communications between the space data network 110 and the clique 126-b.

In the system 100, communication among ground stations of the ground network 120 is relatively inexpensive compared to communication between a satellite of the space data network 110 and a ground station of the ground network 120. Accordingly, for example, given that ground-to-ground forwarding of data among the ground stations of the region 122 is relatively inexpensive compared to space-ground forwarding of data, a dominant decision-making factor used by a given clique 126 in electing a ground gateway (i.e., clique head) and electing space gateway node with which the ground gateway is to interact is the QoS of the space-ground link (i.e., network-to-network communication link 130) between the elected ground gateway and the elected space gateway node. For example, with reference back to the clique 126-a, the ground station G1 and the ground station G2 may determine that, among candidate network-to-network communication links 130 between the satellites A through E of the space data network 110 and the ground stations of the clique 126-a, the network-to-network communication link 130-a between the ground station G1 and the satellite B has the relatively highest QoS.

Additionally, or alternatively, the system 100 may determine suitable gateway pairs between satellites of the space data network 110 and ground stations of the ground network 120 based on pre-loaded topology information, received signal strength indicator (RSSI), packet error rate (PER), or other correlates. In some embodiments, the system 100 may establish a single gateway (i.e., a satellite and ground station pairing and a corresponding network-to-network communication link 130) per clique 126 for maintaining secure space-ground connections between the clique 126 and the space data network 110, rather than multiple gateways, given the cost of maintaining such secure space-ground connections (distributed/revoking keys, etc.) for each of the gateways. However, embodiments of the present disclosure are not limited thereto, and the system 100 is capable of establishing multiple gateways per clique 126 as applicable or desired by the system 100.

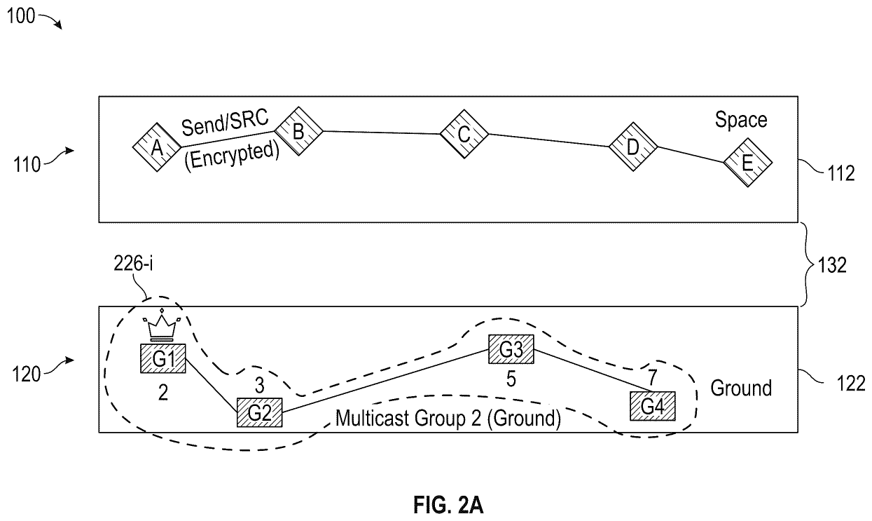

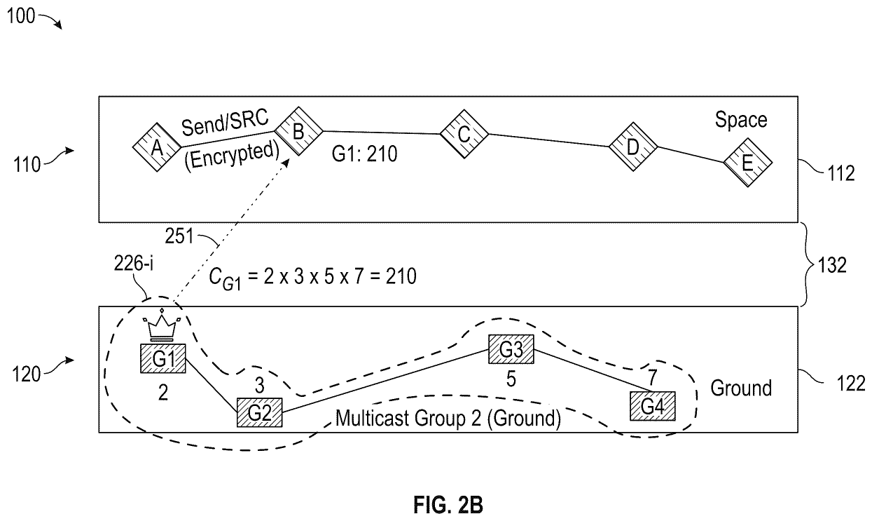

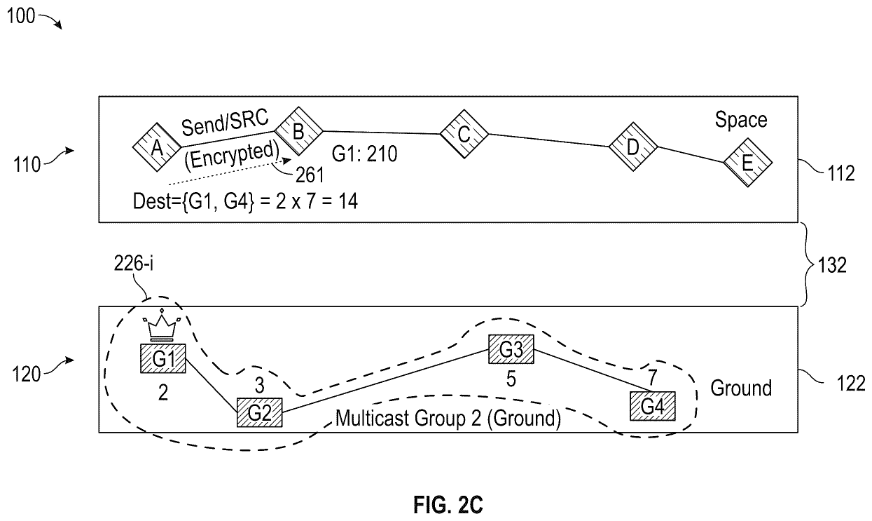

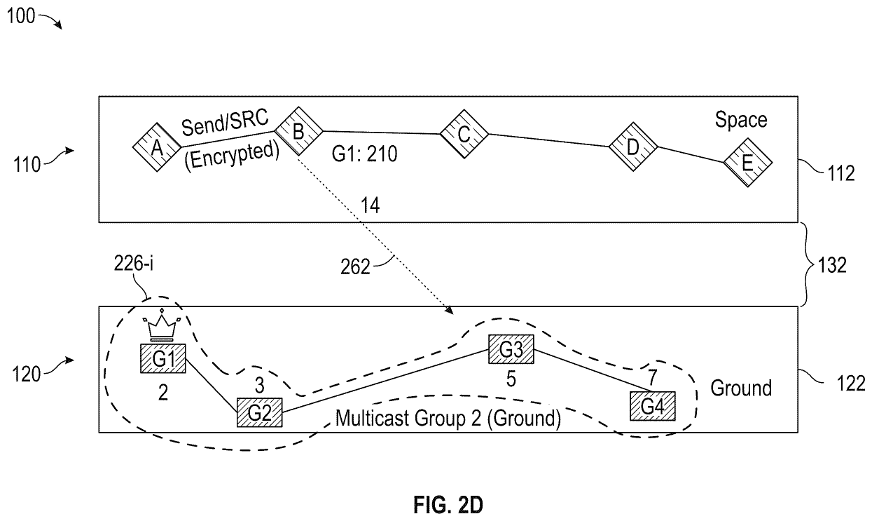

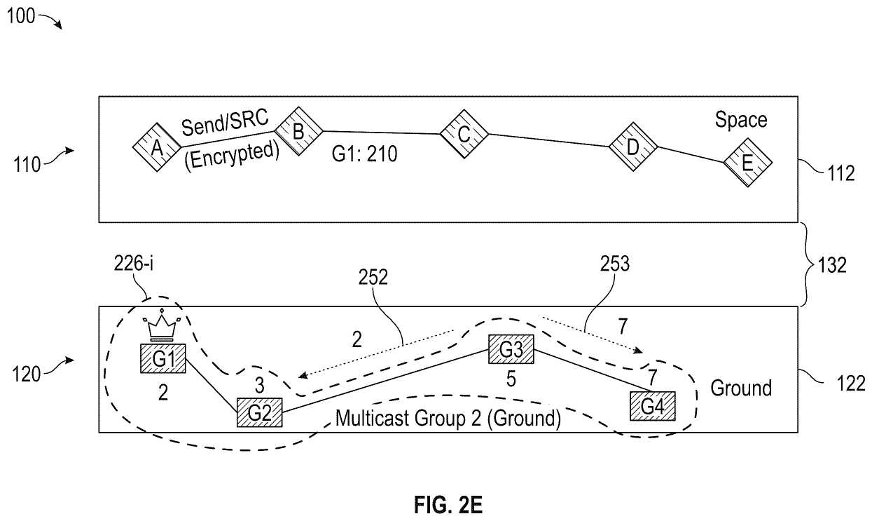

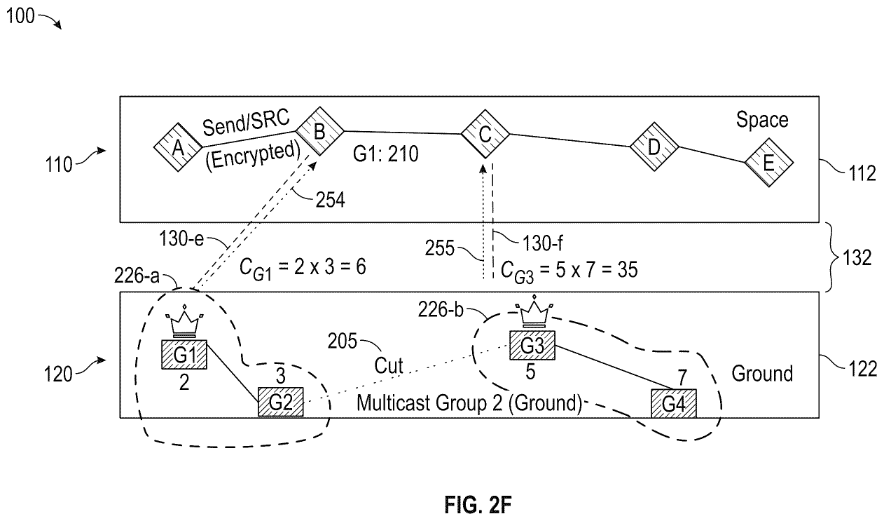

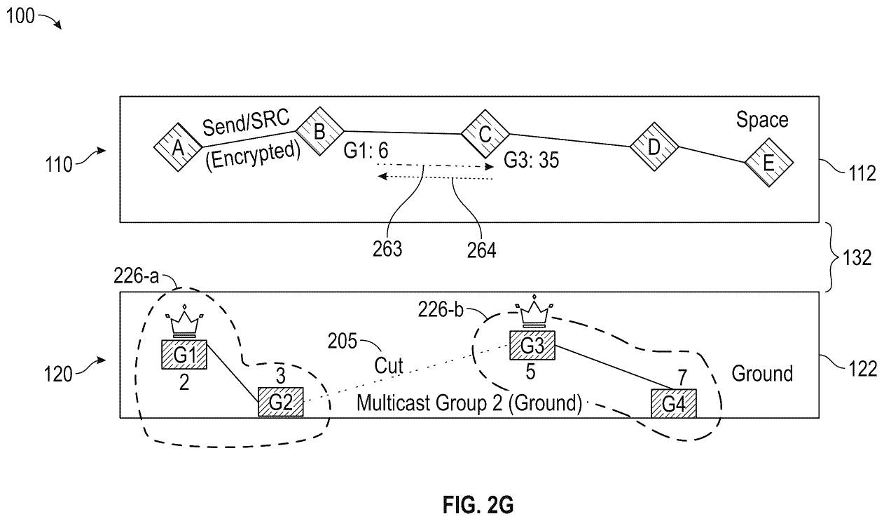

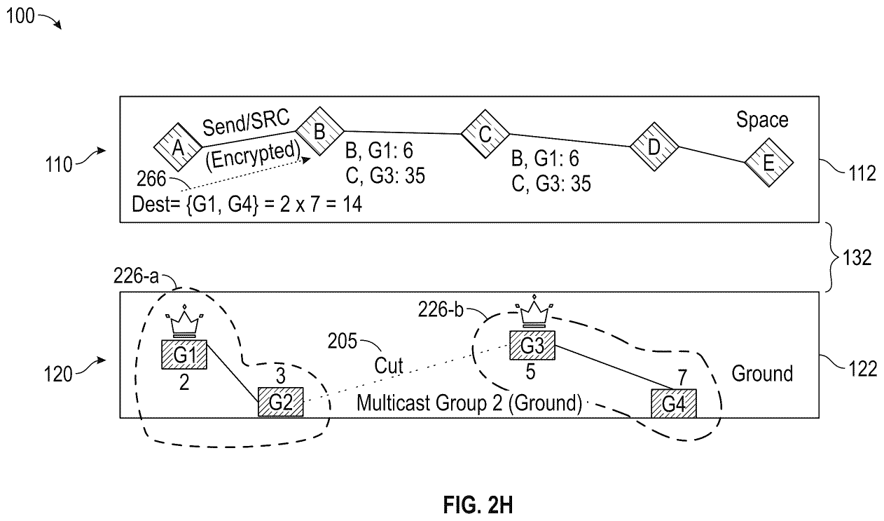

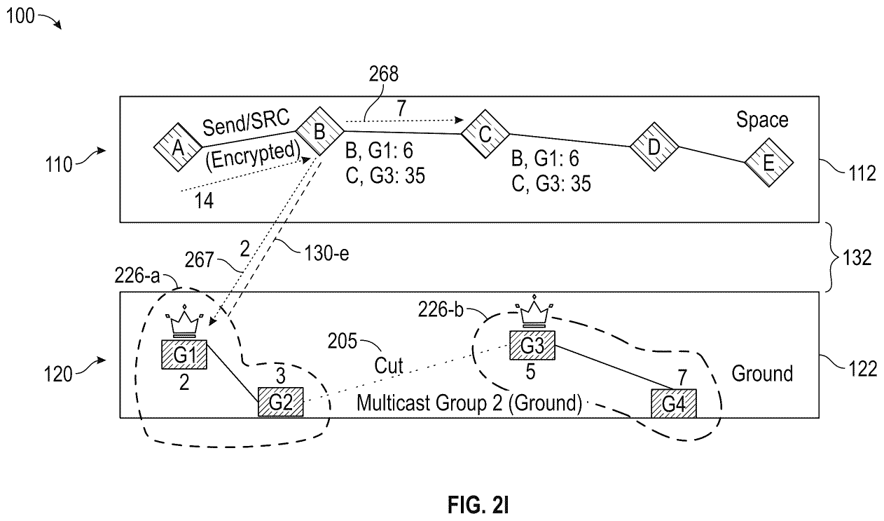

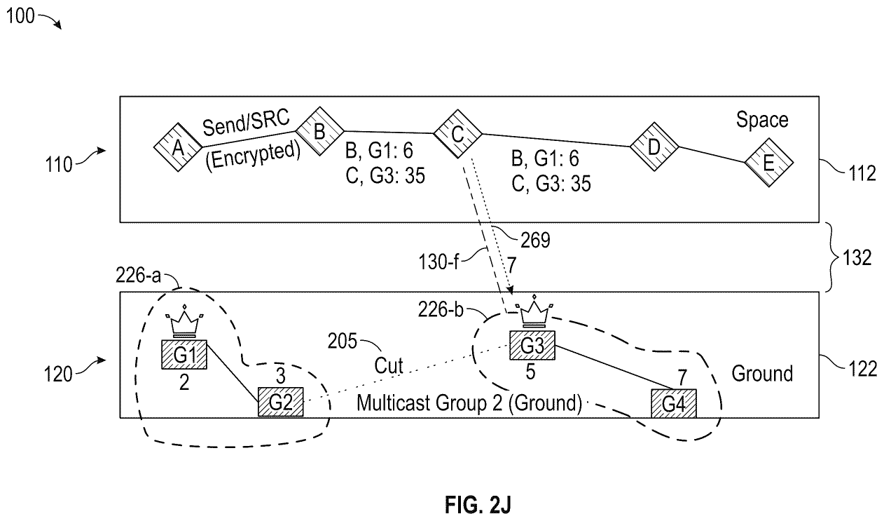

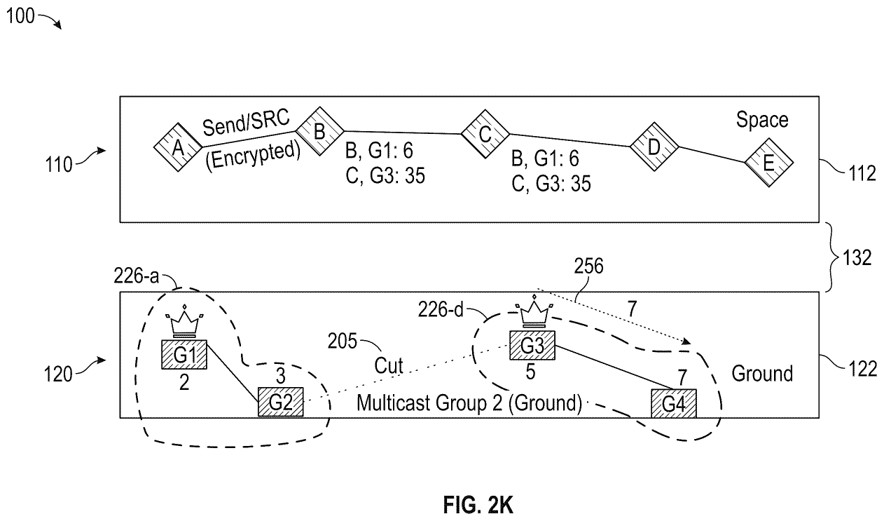

FIG. 2A through FIG. 2K illustrate example aspects of the delivery of a multi-destination packet using the multicast routing architecture of the system 100 in accordance with one or more embodiments of the present disclosure. In the examples, the ground stations G1 through G4 of the ground network 120 are included in a clique 226-i (i.e., an initial clique). Repeated descriptions of like elements are omitted for brevity.

With reference to FIG. 2A, each ground station (i.e., ground station G1 through ground station G4) has a unique prime identifier pᵢ. Each clique 226 (e.g., clique 226-i) of the ground network 120 has a leader ground station (i.e., clique head), determined based on the ground station having the smallest prime identifier. For example, among the ground station G1 through the ground station G4 having respective prime identifiers of ‘2’, ‘3’, ‘5’, and ‘7’, the ground station G1 has a prime identifier of ‘2’ and is the leader ground station. Each clique 226 may also be referred to as a partition of the ground network 120.

The membership of the clique 226-i can be represented by a composite number [symbol] , defined by equation (1):

$${C}_{i} = {ς}_{i ∈ g} {p}_{i} . \qquad ( 1 )$$

With reference to FIG. 2B, in applying the equation (1) to the system 100, the membership of the clique 226-i is represented by a composite number C_{G1}=2×3×5 ×7=210. In an example, the ground station G1 (the leader node) transmits a ground-to-space signal (a transmission 251) with the satellite B (receiver) via a network-to-network communication link 130 (not illustrated). The transmission 251 includes data which includes the composite number C_{G1}. Based on the composite number C_{G1}, the satellite B can determine that there is a connected segment G of ground stations G1 through G4, and that the connected segment is comprised of the prime identifiers (prime factors) ‘2’, ‘3’, ‘5’, and ‘7’of the composite number C_{G1}.

With reference to FIG. 2C, for a source satellite which is to send a multicast communication, the source satellite can utilize a multicast destination address which is the product of the prime identifiers (prime factors) all receivers for which the multicast communication is intended. In an example, the satellite A intends to transmit a packet to ground station G1 and ground station G4. The satellite A uses, as the multicast destination address, a destination value ={G1,G4}=2×7=14. The satellite A sends, to the satellite B, a transmission 261 which includes the data packet of the multicast communication and the destination value of ‘14’.

With reference to FIG. 2D, based on the directory which has been disseminated among the satellites as described herein, the satellite B knows that the clique 226-i led by the ground station G1 has a value of ‘210’ (i.e., G1: 210). Based on the knowledge from the directory, the satellite B determines that the satellite B can deliver the data packet to any ground station having a prime identifier that is a prime factor of ‘210’, and the remainder of the forwarding of the data packet can be handled ground-to-ground among the ground stations of the ground network 120. In the example of FIG. 2D, the satellite B delivers the data packet to the ground station G3 (which has a prime identifier of ‘5’) via a transmission 262.

With reference to FIG. 2E, to prevent re-circulation, loops, or the like of multicast data packet, the system 100 can divide out destination identifiers based on the output interface of the ground station G3. For example, the West interface of the ground station G3 can be designated by the system 100 as responsible for delivery to ground stations which are in a first direction (e.g., West) of the ground station G3, and the east interface can be designated as responsible for delivery to ground stations which are in a second direction (e.g., East) of the ground station G3.

In the example of FIG. 2E, the ground station G3 uses the West interface for delivering the data packet (or a portion of the data packet) to the ground station G2 via a transmission 252, and the ground station G2 delivers the data packet to the ground station G1 via a further transmission (not illustrated). Further, the ground station G3 uses the East interface for delivering the data packet (or a portion of the data packet) to the ground station G4 via a transmission 253.

With reference to FIG. 2F, the system 100 can perform a ground link cut 205 for repartitioning the ground stations of the ground network 120 and determining new cliques 226. For example, the system 100 repartitions the ground network 120 into a clique 226-a which includes ground station A and ground station B, and further, a clique 226-b which includes ground station C and ground station D.

Following the ground link cut 205, the respective ground stations of the clique 226-a and the clique 226-b may perform a leader election described herein (i.e., elect a gateway node for communicating with the space data network 110). For example, the ground stations (i.e., ground station G1 and ground station G2) of the clique 226-a determine that network-to-network communication link 130-e between satellite B and ground station G1 (i.e., the elected gateway node) has the relatively highest QoS for communicating between the space data network 110 and the ground stations (i.e., ground station G1 and ground station G2) of the clique 126-a. In another example, the ground stations (e.g., ground station G3 and ground station G4) of the clique 226-b determine that network-to-network communication link 130-f between the satellite C and the ground station G3 (i.e., the elected gateway node) has the relatively highest QoS for communicating between the space data network 110 and the ground stations (e.g., ground station G3 and ground station G4) of the clique 126-b. In some aspects, each of elected gateway node may evaluate candidate network-to-network communication links 130 respective to the elected gateway node and select the network-to-network communication link 130 for communicating with the space data network 110.

Further, the G1 and G3 advertise their new membership values to the space data network 110. For example, the ground station G1 sends a transmission 254 to the satellite B, indicating an updated composite number C_{G1} for the ground station G1 (and the clique 226-a), in which the composite number C_{G1}=2×3=6. Further, for example, the ground station G3 sends a transmission 255 to the satellite C, indicating an updated composite number C_{G3} for the ground station G3 (and the clique 226-b), in which the composite number C_{G1}=2×3=6.

With reference to FIG. 2G, the system 100 can implement a space-to-space synchronization between the satellites of the space data network 110. In an example, the satellite B sends a transmission 263 to the satellite C, indicating the updated composite number C_{G1} of ‘6’ for the ground station G1 and the ground station G2 of the clique 226-a. For example, the transmission 263 may indicate ‘G1:6’. The satellite C may further send a transmission (not illustrated) including the same information to the satellite D, and the satellite D may further send a transmission (not illustrated) including the same information to the satellite E.

In a further example, the satellite C sends a transmission 264 to the satellite B, indicating the updated composite number C_{G3} of ‘35’ for the ground station G3 and the ground station G4 of the clique 226-b. For example, the transmission 264 may indicate ‘G3:35’. The satellite B may further send a transmission (not illustrated) including the same information to the satellite A.

With reference to FIG. 2H, the satellite A intends to transmit a data packet to the ground station G1 and the ground station G4. The satellite A uses, as the multicast destination address, a destination value ={G1,G4}=2×7=14. In the example, the satellite A sends a transmission 266 to the satellite B, in which the transmission 266 includes the data packet of the multicast communication and the destination value of ‘14’ (i.e., the product of the respective prime identifiers ‘2’ and ‘7’ of the ground station G1 and the ground station G4).

With reference to FIG. 2I, based on the directory shared among the satellites of the space data network 110, which has been updated (as described with reference to FIG. 2F) with the updated composite number C_{G1} of ‘6’ for the clique 226-a and the updated composite number C_{G3} of ‘35’ for the clique 226-b, the satellite B sends a transmission 267 with the data packet (or a portion of the data packet) to the ground station G1 (having the prime identifier of ‘2’) via the network-to-network communication link 130-e

Further in the example, to further utilize ground-to-ground forwarding among the ground stations of the ground network 120, the satellite B first attempts to identify a ground station having the prime identifier of ‘7’ from among the ground stations of the clique 226-a. In response to failing to identify a ground station having the prime identifier of ‘7’, the satellite B may search for a satellite which has access to a clique 226 containing a ground station having a prime identifier of ‘7’. Based on the transmission 264 earlier provided by the satellite C, the satellite B is aware that the satellite C has access to the clique 226-b, which contains the ground station G4 having a prime identifier of ‘7’. Accordingly, for example, the satellite B sends a transmission 268 to the satellite C, in which the transmission 268 includes the data packet of the multicast communication and a destination value of ‘7’ (i.e., the value resulting from dividing the destination value of ‘14’by the prime identifier ‘2’of the ground station G1).

With reference to FIG. 2J, the satellite C sends a transmission 269 including the data packet (or a portion of the data packet) to the ground station G3 via the network-to-network communication link 130-f.

With reference to FIG. 2K, the ground station G3 sends a transmission 256 including the data packet (or a portion of the data packet) to the ground station G4 in a ground-to-ground communication via the ground network 120.

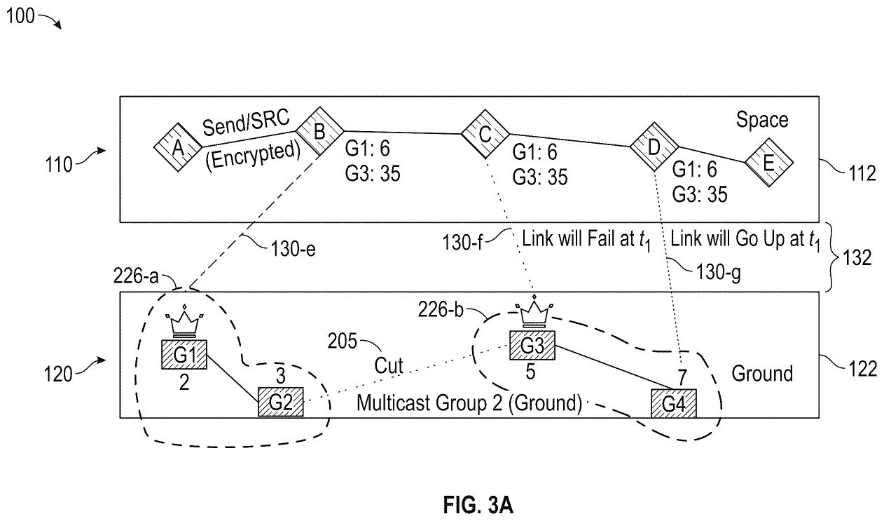

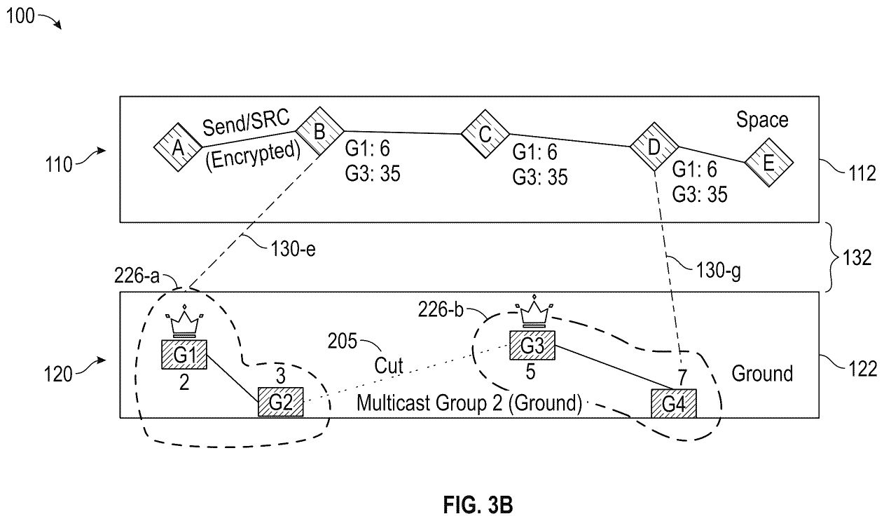

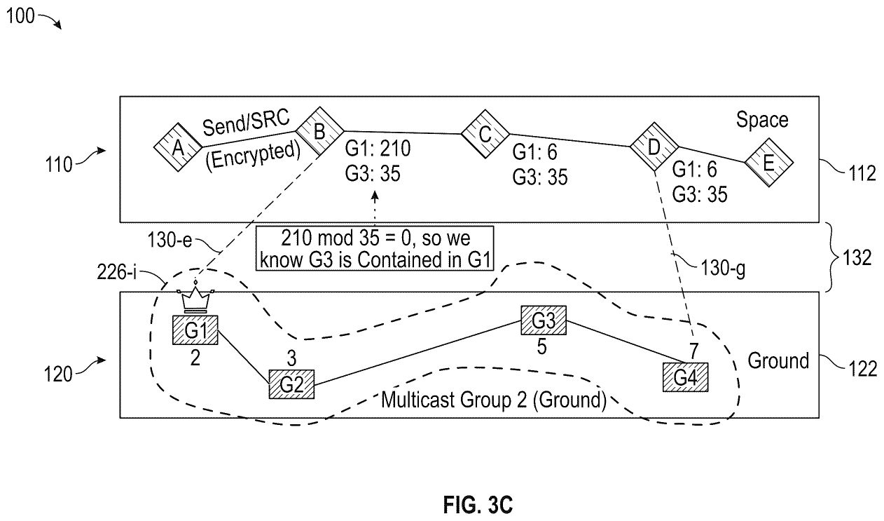

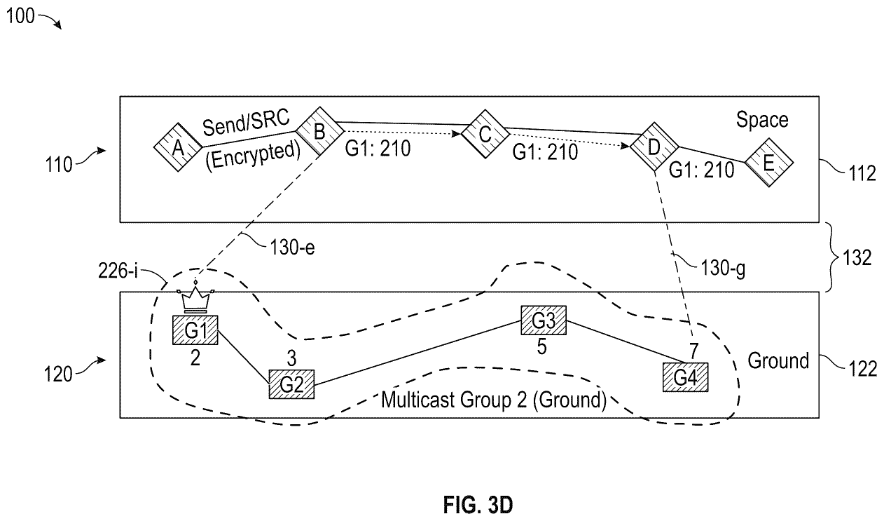

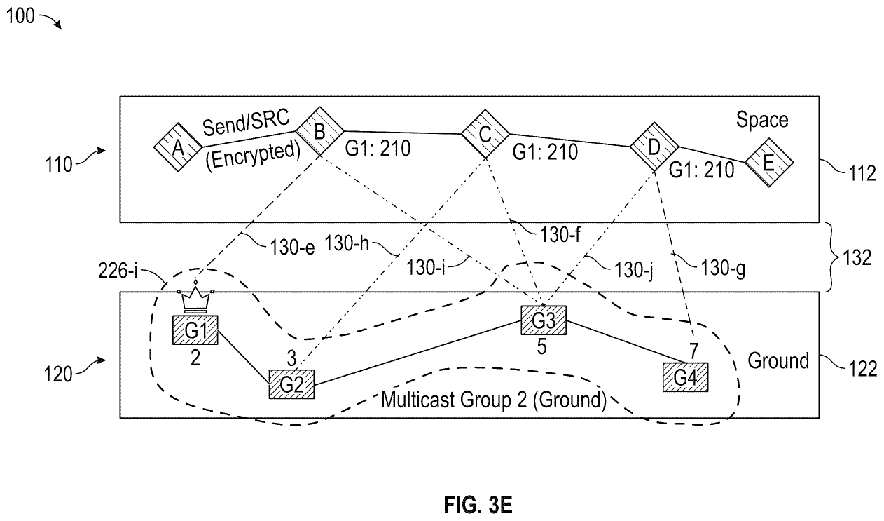

FIG. 3A through FIG. 3E illustrate example aspects of pre-emptive path change using products as implemented by the system 100 in accordance with one or more embodiments of the present disclosure. The system 100 may apply the pre-emptive path change for cases of expected link failure. Repeated descriptions of like elements are omitted for brevity.

With reference to FIG. 3A, the system 100 identifies that, at a time instance t1, the network-to-network communication link 130-f will fail, and further, that a network-to-network communication link 130-g between the satellite D and the ground station G4 will be established. In an example case in which the space data network 110 is a LEO communication network, the failure of the network-to-network communication link 130-f may be from a loss of signal due to terrestrial obstructions (i.e., Earth fade) resulting from the rotation of the Earth. In another example case, the failure of the network-to-network communication link 130-f may be, for example, based on a scheduled maintenance/downtime of the ground station G3.

With reference to FIG. 3B, the space data network 110 may continue to deliver data to the ground network 120 as described herein without further signaling among the satellites. Based on the directory (and included routing table) and updated composite numbers exchanged between the satellites A through E, all of the satellites already know how to deliver multicast data to the ground station G3 and the ground station G4.

For the case of the failure of the network-to-network communication link 130-f, the space data network 110 and the ground network 120 is still capable of delivering data packets from the satellite A to the ground station G3 via the satellite B, the satellite C, the satellite D, the network-to-network communication link 130-g, and the ground station G4.

With reference to FIG. 3C, to further support effective delivery of data packets via the ground network 120 while minimizing costs associated with data transmission via network-to-network communication links 130, the system 100 may reestablish the ground-to-ground communication between the clique 226-a and the clique 226-b. That is, the system 100 may repair the ground link cut 205 earlier described herein and reestablish the clique 226-i.

Further, the system 100 is capable of determining whether a given network-to-network communication links 130 (e.g., network-to-network communication link 130-f) is outdated or no longer valid. For example, the description “210 mod 35=0, so we know G3 is contained in G1” illustrated in FIG. 3C is the observation by the satellite B to delete the local directory entry “G3: 35” in response to a more recent directory entry “G1:210” for the clique 226-i. That is, the directory entry “G1:210” includes all ground stations (nodes) in the clique 35, since 210 mod 35=0. This is a cue for the satellite B (and other satellites) that the entry “G3:35” is outdated and that ground station G1 is to be the new gateway for reaching ground station G3 (having a prime identifier ‘5’) and ground station G4 (having a prime identifier ‘7’.

With reference to FIG. 3D, the updated group information associated with the clique 226-i is flooded to other gateways of the space data network 110. That is, the satellite B can transmit an indication of the updated composite number C_{G1}=2×3×5×7 =210 for the clique 226-i to the satellite C, and the satellite C can transmit an indication of the updated composite number C_{G1} to other satellites (e.g., any satellites (not illustrated) located between satellite C and satellite D). Further, for example, the satellite D can transmit an indication of the updated composite number C_{G1}=2×3×5×7=210 for the clique 226-i to the satellite E, and the satellite E can transmit an indication of the updated composite number C_{G1} to other satellites (not illustrated) as applicable.

With reference to FIG. 3E, based on the directory and the updated composite number C_{G1}=2×3×5×7=210, the satellites B through D are aware that the ground station G1 through the ground station G4 are part of the same clique 226-i and connected via ground-to-ground communications. Accordingly, for example, if the satellite B (or satellite C or satellite D) intends to deliver a data packet to any of the ground station G1 through the ground station G4, the satellite B may transmit the data packet to a single ground station (e.g., ground station G1) of the clique 226-i via any of network-to-network communication link 130-e through network-to-network communication link 130-j, and the recipient ground station can further deliver/route the data packet (or portion of the data packet) to other ground stations of the clique 226-i via ground-to-ground communications supported by the ground network 120.

As has been described herein in accordance with one or more embodiments of the present disclosure, the system 100 and techniques provide a multicast routing architecture for communication between nodes of a first network (e.g., space data network 110, a low-orbit constellation data network) and nodes of a second network (e.g., ground network 120) having different wireless communication capabilities, node-to-node communication costs, and the like. The systems and techniques support multi-destination delivery management between the first network and the second network using the 2-tier hierarchy of the multicast routing architecture, in contrast to systems which determine multicast routes by constructing a minimum spanning tree. Such other systems and approaches fail to address ground-to-ground dynamics.

The multicast routing architecture and communication techniques described herein combine distributed directories with in-tree multicast signaling in a manner which minimizes control plane flooding.

The multicast routing architecture and communication techniques described herein apply relatively low overhead mathematical equations for effectively encoding multicast group membership and multi-destination packet addresses. Multicast groups are represented as composite numbers that explicitly encode forwarding directions and intended recipients, as opposed to using a multicast group address as used in other approaches. Costly communication between space and ground networks is minimized by creating a hierarchical organization of space and ground multicast using the techniques described herein.

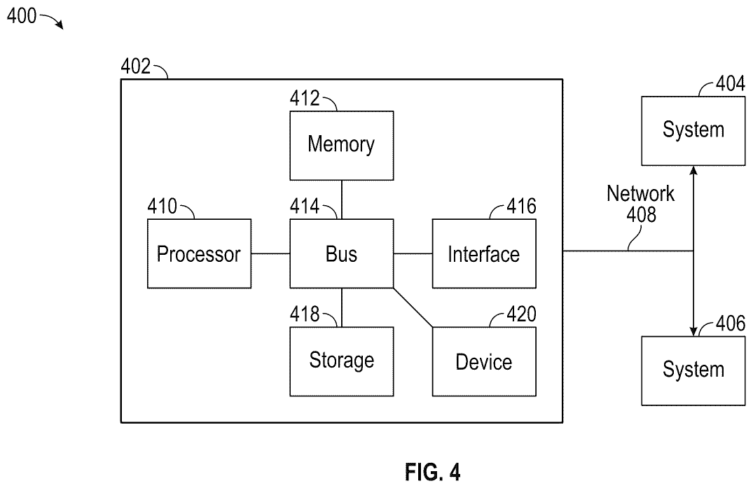

FIG. 4 is a block diagram of a distributed computer system 400, in which various aspects and functions discussed herein may be practiced. The distributed computer system 400 may include one or more computer systems. For example, as illustrated, the distributed computer system 400 includes three computer systems 402, 404 and 406. As shown, the computer systems 402, 404 and 406 are interconnected by, and may exchange data through, a communication network 408. The network 408 may include any communication network through which computer systems may exchange data. To exchange data via the network 408, the computer systems 402, 404, and 406 and the network 408 may use various methods, protocols and standards including, among others, token ring, Ethernet, Wireless Ethernet, Bluetooth, radio signaling, infra-red signaling, TCP/IP, UDP, HTTP, FTP, SNMP, SMS, MMS, SS7, JSON, XML, REST, SOAP, CORBA IIOP, RMI, DCOM and Web Services.

The computer systems 402, 404, and 406 and the network 408 may include any computing devices comprising substantially similar capabilities, descriptions, functions, and configurations as described herein. Devices connected via a network may also be referred to as nodes.

The network 408 may comprise any network or number of networks including the Internet, local area networks, metropolitan area networks, and wide area networks. The network 408 may comprise computing devices connected via cables, IR ports, wireless signals, or any other means of connecting multiple computing devices.

The network 408 may comprise mobile telephone networks utilizing any protocol or protocols used to communicate among mobile devices, including AMPS, TDMA, CDMA, GSM, GPRS or UMTS. The network 408 may comprise a number of physically distinct networks, or the network 408 may comprise a unified network. The network 408 may have any network topology, and any devices or networks within the network 408 may be connected in any manner.

An embodiment of a node (e.g., node H, node D, node D′, node D″, node N, node GH, node U) described herein includes devices and/or systems for communicating with other nodes and may be implemented by a computing device (e.g., any of computer systems 402, 404, and 406) described herein. For example, each node may include a communication system having a suitable device 420 including an antenna or other transmitter/receiver for communicating with the network 408, generating and transmitting signals for communicating over the network 408, receiving and decoding signals received over the network 408, and the like.

In an example, the device 420 may include one or more transceiver devices supportive of communications using one or more communications protocols (e.g., LTE, 4G, 5G, WiFi, Bluetooth, TDMA, CDMA, FDMA, fiber, transmission schemes supportive of LEO, MEO, or GEO satellite communications, or the like). Embodiments of the present disclosure are not limited thereto, and the device 420 may include other transceiver devices supportive of communications using protocols other than the example protocols described herein.

According to some embodiments, the functions and operations discussed herein for multicast routing can be executed on computer systems 402, 404 and 406 individually and/or in combination. For example, the computer systems 402, 404, and 406 support, for example, participation in a collaborative network. In one alternative, a single computer system (e.g., 402) can perform the multicast routing described herein. The computer systems 402, 404 and 406 may include personal computing devices such as cellular telephones, smart phones, tablets, “phablets,” etc., and may also include desktop computers, laptop computers, etc.

Various aspects and functions in accordance with embodiments discussed herein may be implemented as specialized hardware or software executing in one or more computer systems including the computer system 402 shown in FIG. 4. In one embodiment, computer system 402 is a personal computing device specially configured to execute the processes and/or operations discussed herein. As depicted, the computer system 402 includes at least one processor 410 (e.g., a single core or a multi-core processor), a memory 412, a bus 414, input/output interfaces (e.g., 416) and storage 418. The processor 410, which may include one or more microprocessors or other types of controllers, can perform a series of instructions that manipulate data. As shown, the processor 410 is connected to other system components, including a memory 412, by an interconnection element (e.g., the bus 414).

The memory 412 and/or storage 418 may be used for storing programs and data during operation of the computer system 402. For example, the memory 412 may be a relatively high performance, volatile, random access memory such as a dynamic random access memory (DRAM) or static memory (SRAM). In addition, the memory 412 may include any device for storing data, such as a disk drive or other non-volatile storage device, such as flash memory, solid state, or phase-change memory (PCM). In further embodiments, the functions and operations discussed with respect to multicast routing can be embodied in an application that is executed on the computer system 402 from the memory 412 and/or the storage 418. For example, the application can be made available through an “app store” for download and/or purchase. Once installed or made available for execution, computer system 402 can be specially configured to execute the functions associated with multicast routing.

Computer system 402 also includes one or more interfaces 416 such as input devices (e.g., camera for capturing images), output devices and combination input/output devices. The interfaces 416 may receive input, provide output, or both. The storage 418 may include a computer-readable and computer-writeable nonvolatile storage medium in which instructions are stored that define a program to be executed by the processor. The storage 418 (storage system) also may include information that is recorded, on or in, the medium, and this information may be processed by the application. A medium that can be used with various embodiments may include, for example, optical disk, magnetic disk or flash memory, SSD, among others. Further, aspects and embodiments are not to a particular memory system or storage system.

In some embodiments, the computer system 402 may include an operating system that manages at least a portion of the hardware components (e.g., input/output devices, touch screens, cameras, etc.) included in computer system 402. One or more processors or controllers, such as processor 410, may execute an operating system which may be, among others, a Windows-based operating system (e.g., Windows NT, ME, XP, Vista, 7, 8, or RT) available from the Microsoft Corporation, an operating system available from Apple Computer (e.g., MAC OS, including System X), one of many Linux-based operating system distributions (for example, the Enterprise Linux operating system available from Red Hat Inc.), a Solaris operating system available from Oracle Corporation, or a UNIX operating systems available from various sources. Many other operating systems may be used, including operating systems designed for personal computing devices (e.g., iOS, Android, etc.) and embodiments are not limited to any particular operating system.

The processor and operating system together define a computing platform on which applications (e.g., “apps” available from an “app store”) may be executed. Additionally, various functions for generating and manipulating images may be implemented in a non-programmed environment (for example, documents created in HTML, XML or other format that, when viewed in a window of a browser program, render aspects of a graphical-user interface or perform other functions). Further, various embodiments in accord with aspects of the present disclosure may be implemented as programmed or non-programmed components, or any combination thereof. Various embodiments may be implemented in part as MATLAB functions, scripts, and/or batch jobs. Thus, the disclosure is not limited to a specific programming language and any suitable programming language could also be used.

Although the computer system 402 is shown by way of example as one type of computer system upon which various functions for multicast routing may be practiced, aspects and embodiments are not limited to being implemented on the computer system, shown in FIG. 4. Various aspects and functions may be practiced on one or more computers or similar devices having different architectures or components than that shown in FIG. 4.

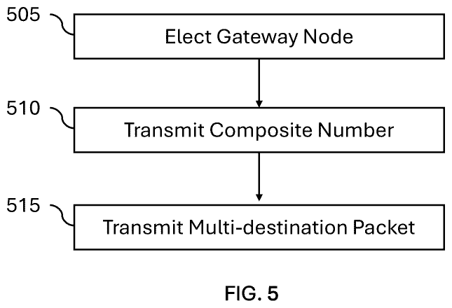

FIG. 5 illustrates an example flowchart of a method 500 of transmitting a multi-destination packet over a first communications network including first nodes and a second communications network including a group of second nodes, in accordance with one or more embodiments of the present disclosure. The method 500 may be implemented by the example aspects of a system 100 or distributed computer system 400 described herein.

At block 505, the method 500 includes electing, by the group of second nodes, a gateway node from among the group of second nodes based on comparing numerical identifiers which respectively correspond to the second nodes and are different from one another.

At block 510, the method 500 includes transmitting, by the gateway node, the composite number to a first node among the first nodes via a communications link between the gateway node and the first node.

At block 515, the method 500 includes transmitting, via at least one first node among the first nodes, a multi-destination packet to two or more second nodes among the group of second nodes based on: the numerical identifiers which respectively correspond to the second nodes and are different from one another; and a composite number corresponding to the group of second nodes, wherein the composite number is a product of the numerical identifiers.

In some aspects, each of the numerical identifiers is a prime number; and the numerical identifier of the gateway node is a smallest prime number among the numerical identifiers.

In some aspects, the method 500 may include: comparing, by the gateway node, quality-of-service values of network-to-network communication links respectively between the first nodes and the gateway node; and selecting, by the gateway node, the communications link from among the network-to-network communication links, based on a result of comparing the respective quality-of-service values.

In some embodiments, the method 500 may include: storing, by at least one of the first nodes, a directory including: the composite number, the numerical identifiers, and a mapping between the composite number and the numerical identifiers; and transmitting, by the at least one of the first nodes, control signaling including: the directory, the composite number, one or more the numerical identifiers, or a combination thereof to another first node among the first nodes.

In some aspects, the method 500 may include transmitting, by the at least one first node among the first nodes, the multi-destination packet to a single second node among the two or more second nodes; and forwarding, by the single second node, at least a portion of the multi-destination packet to another second node among the two or more second nodes, using a communication protocol associated with the second communications network.

In some aspects, the method 500 may include self-partitioning, by the group of second nodes, into a first subgroup of second nodes and a second subgroup of second nodes; transmitting, by a first gateway node among the first subgroup of second nodes, a first composite number to a first node among the first nodes via a communications link between the first gateway node and the first node, wherein the first composite number corresponds to the first subgroup of second nodes and is a product of the numerical identifiers which respectively correspond to the first subgroup of second nodes; and transmitting, by a second gateway node among the second subgroup of second nodes, a second composite number to a different first node among the first nodes via a communications link between the second gateway node and the different first node, wherein the second composite number corresponds to the second subgroup of second nodes and is a product of the numerical identifiers which respectively correspond to the second subgroup of second nodes.

In some aspects, the method 500 may include electing, by the first subgroup of second nodes, the first gateway node from among the first subgroup of second nodes based on the numerical identifier which respectively corresponds to the first gateway node; and electing, by the second subgroup of second nodes, the second gateway node from among the second subgroup of second nodes based on the numerical identifier which respectively corresponds to the second gateway node.

In some aspects, the method 500 may include partitioning the group of second nodes into a first subgroup of second nodes and a second subgroup of second nodes. In some aspects, the method 500 may include transmitting, by a first node among the first nodes, at least a portion of a first multi-destination packet to a first gateway node of the first subgroup of second nodes and transmit the first multi-destination packet to another first node among the first nodes, based on: a numerical identifier corresponding to a first destination node included among the first subgroup of second nodes; a first composite number corresponding to the first subgroup of second nodes, wherein the first composite number is a product of the numerical identifiers which respectively correspond to the first subgroup of second nodes; a numerical identifier corresponding to a second destination node included among the second subgroup of second nodes; and a second composite number corresponding to the second subgroup of second nodes, wherein the composite number is a product of the numerical identifiers which respectively correspond to the second subgroup of second nodes. In some aspects, the method 500 may include transmitting, by the other first node among the first nodes, at least a second portion of the first multi-destination packet to a second gateway node of the second subgroup of second nodes, based on: the numerical identifier corresponding to the second destination node; and the second composite number corresponding to the second subgroup of second nodes.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system comprising:
a first communications network comprising first nodes; and
a second communications network comprising a group of second nodes,
wherein each of the first nodes is configured to transmit a multi-destination packet to two or more second nodes among the group of second nodes based on:
numerical identifiers which respectively correspond to the second nodes and are different from one another; and
a composite number corresponding to the group of second nodes, wherein the composite number is a product of the numerical identifiers.

2. The system of claim 1, wherein:
the group of second nodes is configured to elect a gateway node from among the group of second nodes based on a comparison among the numerical identifiers; and
the gateway node is configured to transmit the composite number to a first node among the first nodes via a communications link between the gateway node and the first node.

3. The system of claim 2, wherein:
each of the numerical identifiers is a prime number; and
the numerical identifier of the gateway node is a smallest prime number among the numerical identifiers.

4. The system of claim 2, wherein the gateway node is configured to:
compare quality-of-service values of network-to-network communication links respectively between the first nodes and the gateway node; and
select the communications link from among the network-to-network communication links, based on a result of comparing the respective quality-of-service values.

5. The system of claim 2, wherein:
at least one of the first nodes is configured to store a directory comprising: the composite number, the numerical identifiers, and a mapping between the composite number and the numerical identifiers; and
the at least one of the first nodes is configured to transmit control signaling comprising: the directory, the composite number, one or more the numerical identifiers, or a combination thereof to another first node among the first nodes.

6. The system of claim 1, wherein:
each of the first nodes is configured to transmit the multi-destination packet to the two or more second nodes, via a single second node among the two or more second nodes,
wherein the single second node is configured to forward at least a portion of the multi-destination packet to another second node among the two or more second nodes, using a communication protocol associated with the second communications network.

7. The system of claim 1, wherein:
the group of second nodes is configured to self-partition into a first subgroup of second nodes and a second subgroup of second nodes;
a first gateway node among the first subgroup of second nodes is configured to transmit a first composite number to a first node among the first nodes via a communications link between the first gateway node and the first node, wherein the first composite number corresponds to the first subgroup of second nodes and is a product of the numerical identifiers which respectively correspond to the first subgroup of second nodes; and
a second gateway node among the second subgroup of second nodes is configured to transmit a second composite number to a different first node among the first nodes via a communications link between the second gateway node and the different first node, wherein the second composite number corresponds to the second subgroup of second nodes and is a product of the numerical identifiers which respectively correspond to the second subgroup of second nodes.

8. The system of claim 7, wherein:
the first subgroup of second nodes is configured to elect the first gateway node from among the first subgroup of second nodes based on the numerical identifier which respectively corresponds to the first gateway node; and
the second subgroup of second nodes is configured to elect the second gateway node from among the second subgroup of second nodes based on the numerical identifier which respectively corresponds to the second gateway node.

9. The system of claim 1, wherein:
the group of second nodes is partitioned into a first subgroup of second nodes and a second subgroup of second nodes;
a first node among the first nodes is configured to transmit at least a portion of a first multi-destination packet to a first gateway node of the first subgroup of second nodes and transmit the first multi-destination packet to another first node among the first nodes, based on:
a numerical identifier corresponding to a first destination node included among the first subgroup of second nodes;
a first composite number corresponding to the first subgroup of second nodes, wherein the first composite number is a product of the numerical identifiers which respectively correspond to the first subgroup of second nodes;
a numerical identifier corresponding to a second destination node included among the second subgroup of second nodes; and
a second composite number corresponding to the second subgroup of second nodes, wherein the composite number is a product of the numerical identifiers which respectively correspond to the second subgroup of second nodes; and
the other first node among the first nodes is configured to transmit at least a second portion of the first multi-destination packet to a second gateway node of the second subgroup of second nodes, based on:
the numerical identifier corresponding to the second destination node; and
the second composite number corresponding to the second subgroup of second nodes.

10. The system of claim 1, wherein:
the first nodes of the first communications network are configured to transmit and receive signals between one another using a first communication protocol;
the second nodes of the second communications network are configured to transmit and receive signals between one another using a second communication protocol which is different from the first communication protocol; and
the first nodes of the first communications network are configured to transmit and receive signals with the second nodes of the second communications network using a third communication protocol.

11. A method of transmitting a multi-destination packet over a first communications network comprising first nodes and a second communications network comprising a group of second nodes, the method comprising:
transmitting, via at least one first node among the first nodes, a multi-destination packet to two or more second nodes among the group of second nodes based on:
numerical identifiers which respectively correspond to the second nodes and are different from one another; and
a composite number corresponding to the group of second nodes, wherein the composite number is a product of the numerical identifiers.

12. The method of claim 11, further comprising:
electing, by the group of second nodes, a gateway node from among the group of second nodes based on comparing the numerical identifiers; and
transmitting, by the gateway node, the composite number to a first node among the first nodes via a communications link between the gateway node and the first node.

13. The method of claim 12, wherein:
each of the numerical identifiers is a prime number; and
the numerical identifier of the gateway node is a smallest prime number among the numerical identifiers.

14. The method of claim 12, further comprising:
comparing, by the gateway node, quality-of-service values of network-to-network communication links respectively between the first nodes and the gateway node; and
selecting, by the gateway node, the communications link from among the network-to-network communication links, based on a result of comparing the respective quality-of-service values.

15. The method of claim 12, further comprising:
storing, by at least one of the first nodes, a directory comprising: the composite number, the numerical identifiers, and a mapping between the composite number and the numerical identifiers; and
transmitting, by the at least one of the first nodes, control signaling comprising: the directory, the composite number, one or more the numerical identifiers, or a combination thereof to another first node among the first nodes.

16. The method of claim 11, further comprising:
transmitting, by the at least one first node among the first nodes, the multi-destination packet to a single second node among the two or more second nodes; and
forwarding, by the single second node, at least a portion of the multi-destination packet to another second node among the two or more second nodes, using a communication protocol associated with the second communications network.

17. The method of claim 11, further comprising:
self-partitioning, by the group of second nodes, into a first subgroup of second nodes and a second subgroup of second nodes;
transmitting, by a first gateway node among the first subgroup of second nodes, a first composite number to a first node among the first nodes via a communications link between the first gateway node and the first node, wherein the first composite number corresponds to the first subgroup of second nodes and is a product of the numerical identifiers which respectively correspond to the first subgroup of second nodes; and
transmitting, by a second gateway node among the second subgroup of second nodes, a second composite number to a different first node among the first nodes via a communications link between the second gateway node and the different first node, wherein the second composite number corresponds to the second subgroup of second nodes and is a product of the numerical identifiers which respectively correspond to the second subgroup of second nodes.

18. The method of claim 17, further comprising:
electing, by the first subgroup of second nodes, the first gateway node from among the first subgroup of second nodes based on the numerical identifier which respectively corresponds to the first gateway node; and
electing, by the second subgroup of second nodes, the second gateway node from among the second subgroup of second nodes based on the numerical identifier which respectively corresponds to the second gateway node.

19. The method of claim 11, further comprising:
partitioning the group of second nodes into a first subgroup of second nodes and a second subgroup of second nodes;
transmitting, by a first node among the first nodes, at least a portion of a first multi-destination packet to a first gateway node of the first subgroup of second nodes and transmit the first multi-destination packet to another first node among the first nodes, based on:
a numerical identifier corresponding to a first destination node included among the first subgroup of second nodes;
a first composite number corresponding to the first subgroup of second nodes, wherein the first composite number is a product of the numerical identifiers which respectively correspond to the first subgroup of second nodes;
a numerical identifier corresponding to a second destination node included among the second subgroup of second nodes; and
a second composite number corresponding to the second subgroup of second nodes, wherein the composite number is a product of the numerical identifiers which respectively correspond to the second subgroup of second nodes; and
transmitting, by the other first node among the first nodes, at least a second portion of the first multi-destination packet to a second gateway node of the second subgroup of second nodes, based on:
the numerical identifier corresponding to the second destination node; and
the second composite number corresponding to the second subgroup of second nodes.

20. A first node comprised in a first communications network, the first node comprising:
a memory having computer readable instructions and one or more processors for executing the computer readable instructions, wherein the computer readable instructions, when executed by the one or more processors, cause the first node to:
transmit a multi-destination packet to two or more second nodes among a group of second nodes comprised in a second communications network, based on:
numerical identifiers which respectively correspond to the second nodes and are different from one another; and
a composite number corresponding to the group of second nodes, wherein the composite number is a product of the numerical identifiers.
